(19) United States
(12) Patent Application Publication
(10) Pub. No.: US 2012/0221349 A1
(43) Pub. Date: Aug. 30, 2012

(54) SYSTEMS AND METHODS FOR THE PREDICTION OF HEALTH CARE COSTS

(76) Inventor: Eric Mora, Arlington, VA (US)

(21) Appl. No.: 13/405,545

(22) Filed: Feb. 27, 2012

Related U.S. Application Data
(60) Provisional application No. 61/446,625, filed on Feb. 25, 2011.

(51) Int. Cl. G06Q 50/22

(52) U.S. Cl. 705/2

(57) ABSTRACT

A disease state of a patient population of interest, two or more disease outcomes targeted for improvement, two or more treatments, costs for the two or more disease outcomes targeted for improvement, and costs for the two or more treatments are received. An electronic database is searched for treatment outcome data that provides expected effects of the two or more treatments. Two or more deducible measures are created from the search that are a subset of the two or more treatment outcomes targeted for improvement. Improvement values are assigned to the two or more deducible measures for each treatment of the two or more treatments for a time period based on the expected effects found in the search. Cost values are calculated for each of the two or more deducible measures for no treatment and for each treatment of the two or more treatments for the time period.

### CROSS-REFERENCE TO RELATED APPLICATION

This application claims the benefit of U.S. Provisional Patent Application No. 61/446,625, filed Feb. 25, 2011, which is incorporated by reference herein in its entirety.

### INTRODUCTION

1. Field of the Invention

Embodiments of the present invention relate to systems and methods for the calculation of future healthcare costs based on present treatment decisions. More particularly, embodiments of the present invention relate to systems and methods that combine information gathered and inputted from different databases about treatment efficacy, treatment costs, ancillary costs and the costs of disease state outcomes to generate predictions of future costs on a processor.

2. Background

As US health insurance costs continue to rise there needs to be close scrutiny of the cost-effectiveness of treatment decisions. A less expensive treatment may save money in the short term but may have a higher likelihood that a very costly event might happen to the patient in the future. Currently, it is very difficult to predict the difference between the costs of future events which are related to treatment decisions being made in the present. Because of this lack of precision in predicting future costs, decisions that could be very costly in the long run may become the standard of care if the focus is on short-term cost savings. With the Affordable Care Act having been enacted in 2010, which will require every American citizen to carry health insurance, the ability to accurately predict future costs based on treatment decisions made today will be very important to both government and commercial health care payers.

Commonly, the process for making cost-effectiveness healthcare decisions is based on calculating the initial treatment cost and estimating the real-world outcomes. The real-world outcome estimate is typically based on the assumption that the real-world outcome with a particular treatment will be similar to those outcomes seen in randomized, controlled, clinical trials. However, in real-world use, the results of different treatments are often much different from those seen in clinical trials. This can be attributed to factors such as the patient population being treated by the payer having much different baseline characteristics than the patient population which was treated in clinical trials. The costs of the treatment may include much more than just the cost of the medical device, pharmaceutical, or professional fees that are typically associated with that particular treatment. Sources of additional treatment costs could include such ancillary costs as necessary lab work or a higher reimbursement rate to the payer based on sites of service. Lastly, the costs of a given negative outcome to a particular payer, that the treatment is designed to prevent can be much different from the values used in existing independent research for a variety of reasons.

Typically, attempts by health insurance companies and other payers of health care to link future health care costs with current treatment decisions have not included adjustments to their financial projections for real-world variables such as patient compliance, variability in contract rates with providers, or other downstream costs/savings. Current methods have focused largely on estimating current and/or near-term treatment costs. Because there is a need to find ways to achieve the best overall care for patients with the least overall cost, there exists the need for better processes to predict the future healthcare costs of different treatment options that are being chosen in the present.

In view of the forgoing, it can be appreciated that a substantial need exists for systems and methods that can allow for more accurate prediction of future healthcare costs based on treatment decisions and their associated costs in the present.

### BRIEF DESCRIPTION OF VARIOUS EMBODIMENTS

The following descriptions of various methods of the present teachings have been presented for purposes of illustration and description. It is not exhaustive and does not limit the present teachings to the precise form disclosed. Modifications and variations are possible or may be acquired from practicing of the present teachings. Additionally, the described methods include the use of data from multiple databases including but not limited to clinical trial data, contracted payment rates for specific services, data from business intelligence companies, data from focus groups and data from claims databases. Additionally, the present teachings may be implemented to include more databases and sources of information than those listed in these teachings. The present teachings may be implemented by either an employee of a health insurance company or 3^{rd}-party consultants or contractors who are offering these services for hire using a processor, input device, display device, and storage system for imported data. The present teachings may be implemented in the form of a standardized software or template for each disease state in which the analysis is performed or a much simpler, non-proprietary form such as a computer-based spreadsheet. Thus, implementations of the present teachings are not limited to any specific form which the use of these methods and systems described in the present teachings may take.

There are a number of embodiments that can be used in this process of health outcomes cost prediction. The use of multiple embodiments together can give enhanced predictive power to the analysis described in the present invention.

One embodiment is the decision to focus the analysis on specific outcomes that are targeted for reduction. An example of an outcome targeted for reduction would be a measure such as myocardial infarction, stroke or hospitalization that the payer wants to occur less frequently in the patients they are treating. This can mean that selecting a particular disease state would be a natural starting point for the system to begin its analysis, as illustrated in FIG. 2. But it is also recognized that some outcomes might be the result of the interaction of multiple diseases or medical conditions. So it is the selection of the targeted outcomes, not just the disease state, which is important to this first embodiment. Targeted outcomes can include but are not limited to medical events requiring hospitalization, physician visits, medication, surgery, physical therapy or radiographic procedures and non-medical events that in some way affect the finances of the payer including but not limited to termination of the member's policy, member non-compliance with a treatment plan or failure by the member to pay premiums or cost sharing. The targeted outcomes may be selected for reasons such as, but not limited to, cost savings to the health insurance payer, improvement of patient quality of life or extension of life (mortality reduction).

Related to the first embodiment is the selection of certain treatments that will be part of the analysis. Treatments selected can include but are not limited to medications, medical devices, surgical interventions, diagnostic and screening procedures, physical therapy, lifestyle modifications and natural remedies. The treatments selected for analysis could be selected for reasons such as, but not limited to, determining their situation-specific effectiveness on the targeted outcomes or cost savings to the payer.

Another embodiment is the determination of measures which are commonly deducible between the outcomes of different treatment options and payment for different outcomes. The values of this measure are calculated by the system when the system combines data about the treatment options and information about the currently available reimbursement procedures or prospective payments. These need to be measures for which both the expected effectiveness of the different treatment options and the expected costs paid by the fiscally responsible party can be calculated by the system. These measures can include but are not limited to specific diagnosis and reimbursement codes, bundled payments and aggregate categories of diagnosis or reimbursement codes. This allows the system to generate exact values for these measures.

Another embodiment is the assignment of costs to any measure, outcome or other variable in the system. The system will attempt to assign costs using data that is specific to the contracted reimbursement arrangements pertaining to a specific payer and taking into account all factors with might affect those costs including but not limited to provider reimbursement rates, patient cost sharing, manufacturer rebates, volume discounts and site of service variables.

Another embodiment is for the system to make adjustments to the data at multiple points throughout the analysis based on real-world variables or situation specific information that may be available. These adjustments can be made to a variety of different data points including, but not limited to, expected treatment costs, the expected frequency of the outcomes in an untreated population or treated population, expected outcomes costs and expected efficacy of the different treatments chosen.

Another embodiment is to have the system make adjustments to cost predictions for downstream or ancillary costs that may be incurred to the payer as a result of the different treatment options or outcomes selected for analysis. These adjustments could include but are not limited to the costs of additional physician visits or consults during the course of the treatment or as a result of the treatment, the cost of reimbursement for labs performed, the cost of additional medical procedures required as a result of a selected treatment, the cost of additional medications needed, or the cost of other medical equipment used during the procedure. Adjustments for downstream and ancillary costs also include but are not limited to the cost recovery from patient cost sharing, manufacturer rebates, volume discounts, and cost recovery from reimbursements made to entities which are owned by the payer. The ancillary or downstream costs that are accounted for in this embodiment are not limited to the examples given.

The combination of these embodiments is important because existing systems which do not combine these principles do not produce the same accuracy of results as the present teachings. Systems which may be created based on these present teachings, using these embodiments together with additional changes, steps or adjustments would still be incorporating this system and method within that new system which is created.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is an exemplary flowchart showing a method for predicting future health care costs based on current treatment decisions, in accordance with various embodiments.

FIG. 3 is schematic diagram of a system for predicting expected disease outcome costs based on healthcare treatment options, in accordance with various embodiments.

FIG. 4 is an exemplary flowchart showing a method for predicting expected disease outcome costs based on healthcare treatment options, in accordance with various embodiments.

FIG. 5 is a schematic diagram of a system that includes one or more distinct software modules that perform a method for predicting expected disease outcome costs based on healthcare treatment options, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

### Computer-Implemented System

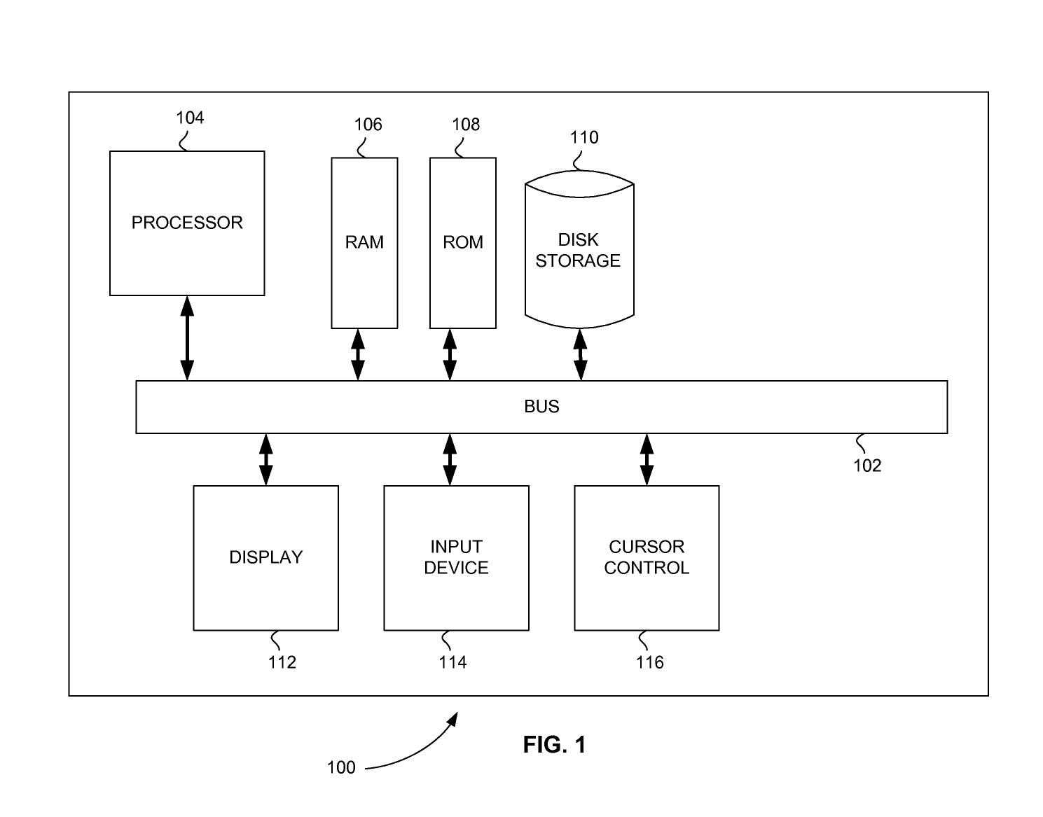

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random access memory (RAM) or other dynamic storage device, coupled to bus 102 for determining base calls, and instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein. Alternatively hard-wired circuitry may be used in place of or in combination with software instructions to implement the present teachings. Thus implementations of the present teachings are not limited to any specific combination of hardware circuitry and software.

The term “computer-readable medium” as used herein refers to any media that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as memory 106. Transmission media includes coaxial cables, copper wire, and fiber optics, including the wires that comprise bus 102.

Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a non-transitory and tangible computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### Systems and Methods of Data Processing

As described above, in real-world use, the results of different treatments are often much different from those seen in clinical trials. The patient population being treated may have much different baseline characteristics. The costs of the treatment may include much more than device, pharmaceutical, or professional fees. And, additionally, can include such things as the variation in reimbursement rates between sites of service. In the past, attempts by payers of health care to link future health care costs with current treatment decisions have not included adjusting their financial projections for real-world or situation specific variables such as patient compliance, unique patient demographics of their insured population and variability in contract rates with providers. In the past, payers have not attempted to find commonly deducible measures between the events that they want to change and the treatments they want to use to change them unless those measures clearly already existed, such as the use of medications specifically used to treat heart failure and a decrease in the diagnosis related group (DRG) payments for heart failure hospitalization. Lastly, in the past, payers have not always accounted for other downstream costs/savings associated with specific treatment such as additional physician visits, lab tests, medical procedures, additional medications needed or payments made by the payer to the hospital which the payer owns.

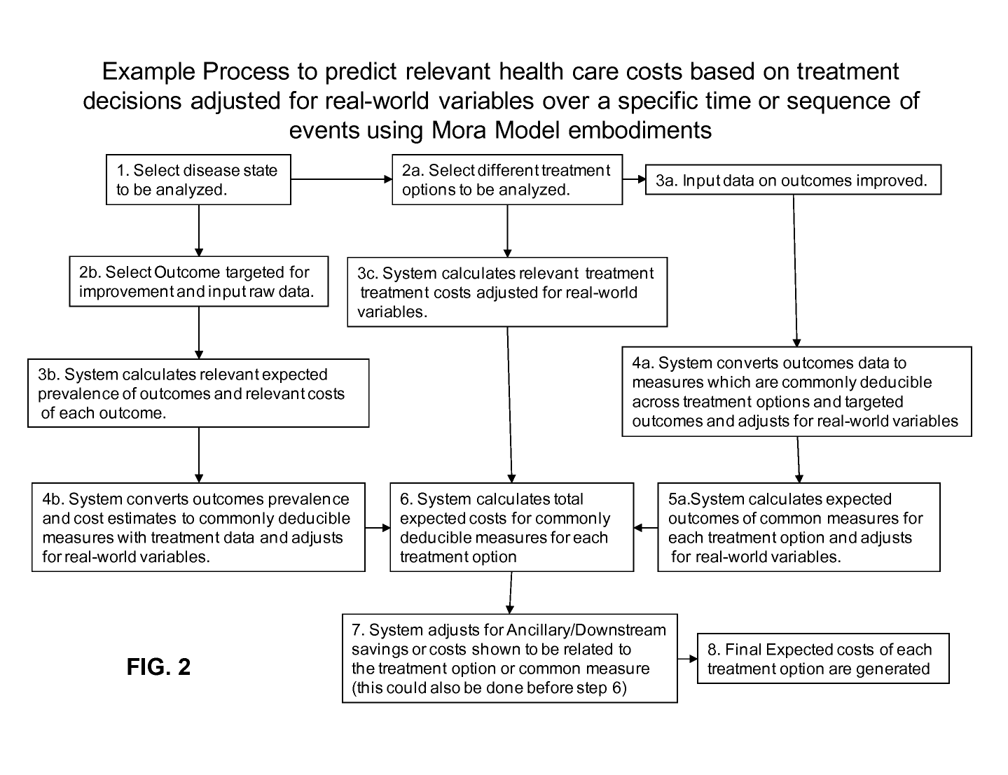

FIG. 2 is an exemplary flowchart showing a method 200 for predicting future health care costs based on current treatment decisions adjusted for real-world and situation specific variables, over a specific period of time or sequence of events in accordance with various embodiments.

Box 1 represents the decision that can be made to select a particular disease state to focus on. This can be a category that includes multiple diseases which share common treatments or it could be a very narrowly focused single disease. Both treatments and the outcomes that are targeted for improvement by the treatments tend to be specific to particular disease states, so it can be convenient to approach cost predictions one disease state at a time.

Box 2a represents the decision to select certain treatment options for the chosen disease state for analysis. These treatment options can be pharmaceutical, surgical, nutritional, clinical or any other treatment that may be used for the particular disease state that has been chosen including the decision not to treat.

Box 3a represents the process of inputting data on the expected outcomes of using the different treatment options from the original data source. The data can be input into the system from multiple databases including published clinical trials or the claims database of a particular payer.

Box 4a represents how the system converts the initial outcomes data into measures that are commonly deducible across all selected treatment options and the outcomes that are targeted for improvement in Box 2b. Because these measures have exact values associated with them by the system, they also are able to have future treatment costs associated with them. The deduction of these measures is what allows for a cost and outcomes comparison across treatment options. Sometimes in clinical trials endpoints are chosen that translate easily to cost reductions, such as the reduction of a hospitalization for heart failure. In this case, the relationship between the claims that are commonly paid by an insurance company that relate to the DRGs (diagnosis related groups) associated with a hospitalization for heart failure and a reduction in heart failure hospitalizations can be made with some directness. Other times in clinical trials, endpoints are chosen which are not so directly translated to insurance claims paid. For example, the endpoint of non-vertebral fractures commonly used in osteoporosis clinical trials, this is a combination of very costly hospitalizations for hip fractures and less costly visits for wrist fractures and a variety of outcomes in between those two. A reduction in non-vertebral fractures can have a wide variety of values to a health insurance company. The best way to estimate the value may be for the system to use some composite measure that the raw data of the clinical trial and the claims database of the insurance company can both produce values for; then the system can calculate the values of these commonly deducible measures using the data from multiple sources.

Box 5a shows the step where the system calculates outcomes for each of the common measures for each treatment group. This means determining how frequently each of the commonly deducible measures will occur in the patient population for each treatment option. These values can be adjusted by the system for a variety of real world variables, which may result in estimated improvements for each treatment option that were significantly different from published clinical data or historical claims data from other payers. Some of these real-world adjustments may include but are not limited to adjusting for compliance variances seen in the population of interest (a possible data source could be refill rates from a claims database) or concomitant use of other medications that were not used in clinical trials.

Box 2b takes the disease state that was selected in Box 1 and selects particular outcomes that are targeted for improvement. These are commonly negative outcomes that a treatment is seeking to reduce, but these outcomes could also be positive outcomes that a treatment is seeking to improve.

In Box 3b, the system uses the outcomes that were selected in the previous step and the values that were inputted with those outcomes, and the system calculates the prevalence of the outcomes in the population which is targeted for improvement and the costs that are relevant to those outcomes. This step produces actual values that serve as a baseline from which one wants to improve and the costs that are associated with those values. Examples of these costs could be total first-year medical costs, medical costs plus lost productivity or the costs for payment on a particular DRG (diagnosis related group).

In Box 3c, the system takes the different treatment options that were selected in Box 2a and the system calculates the relevant treatment costs of each. The relevant treatment costs go beyond the initial price of each treatment and may be affected by variables such as who is paying for what portion of the treatment or any rebates the payer may receive from manufacturers. Beyond these variables there should be adjustments made for real-world variables such as compliance, which can affect the costs of a chosen therapy. This step produces values in the form of expected costs of different treatment options.

Box 6 combines information from boxes 4b, 3c and 5a such that the system calculates the total expected costs for each commonly deducible measure for each treatment option. This means that the system combines the expected treatment costs with the expected costs associated with the commonly deducible measures over a designated period of time or sequence of events. This is the first step where the system generates information for projected total cost comparisons across different treatment options.

Box 7 represents the system making additional adjustments to the data from box 6. There may be additional downstream costs or savings that are realized to the payer such as common complications or ancillary laboratory costs associated with the different treatment options or commonly deducible measures. This could also include adding back in the estimated costs of each treatment. These could potentially be calculated as a part of step 6. Even if some ancillary costs are accounted for in step 6 there may still be others (such as a practice pattern change effect) that can only be accounted for after an initial adjusted total is calculated.

Box 8 represents the results of the process, which are total expected costs for different treatment options and different outcomes within a disease state over a specified period of time or sequence of events. These costs can be based on a variety of different sizes of patient populations and could even be adapted for the specific size patient population that a particular payer is responsible for.

### EXAMPLES

Aspects of the applicant's teachings may be further understood in light of the following examples, which should not be construed as limiting the scope of the present teachings in any way.

An exemplary health insurance company wants to provide better care for its members, while at the same time spending less money on their care. They have many different diseases that they want to improve care for but for this example they decide to focus on osteoporosis. With osteoporosis, the goal of treatment is to reduce bone fractures, the most common being vertebral fractures and the most severe (and costly to treat) being hip fractures. There are two drugs that are used commonly to treat osteoporosis, Drug A and Drug B. Drug A is generic and costs the plan considerably less initially than Drug B. However, the clinical studies for Drug B indicate that it may work better than Drug A. Currently they have a policy that says they will pay for Drug B, only if the patient has first tried Drug A and been unable to tolerate it. This has the effect of steering the majority of the osteoporosis patients in the plan into taking Drug A. Is this a wise policy? Is the plan saving money up front only to spend more in the long run?

The outcomes that the plan wants to reduce are hip fractures (most expensive), vertebral fractures (most common), pelvic fractures (2^{nd} most expensive), wrist fractures (2^{nd} most common) and a catch-all category for all other fractures. Consistent with step 3b of FIG. 2, the health plan needs to determine just how often these fractures seem to be happening to the untreated patients in their plan. This information can be obtained from the claims database of the healthcare company's system. This is found by looking at the number of patients with an osteoporosis diagnosis who also have not made claims for either drug A or drug B and the incidence of claims for fractures within that group. Next the insurance company also needs to determine what their actual average treatment costs are for each fracture type and the total number of patients with an osteoporosis diagnosis covered by the insurance plan. This information can be input into the system to calculate a value of what their total costs for osteoporosis would be over a given period of time (or sequence of events) if no patients were treated. This gives a baseline, or starting point from which the system can estimate the expected improvements in outcomes and reductions in costs of Drug A and Drug B.

Consistent with step 3c of FIG. 2, the treatment costs of Drug A and Drug B over a given period of time need to be calculated. At first glance Drug A costs $120/year and Drug B cost $1200/year, hence the existing policy of only paying for Drug B after Drug A has been tried. However, there may be some other factors that would influence treatment cost over 3 years. For example, Drug A can have an annual patient discontinuation rate of 50% per year confirmed through multiple databases including published clinical trials and the claims database of the insurance company who is conducting this analysis. This would reduce the treatment costs of Drug A even further, but will definitely have a negative effect on the efficacy of Drug A. Similar scrutiny of compliance needs to be applied to Drug B when predicting its costs. Also, for this example, Drug B is experiencing a loss of patent exclusivity in 24 months, which will reduce the expected treatment cost down to $200 in the final year for the portion of patients are expected to complete a full three year course of therapy. Finally, the system calculates what the expected treatment costs to the plan would be over 3 years if every osteoporosis patient uses either drug A or drug B.

To determine the magnitude of the improvement on the targeted outcomes that is expected from each drug, consistent with step 3a of FIG. 2, data must be input into the system about the expected effects of each treatment. This data can come from clinical trials or from the claims database of the insurance company.

If the data for step 4a is coming from clinical trials then the outcomes measured in those trials may not match up exactly with the outcomes that have been targeted. For example, the primary endpoints of most major osteoporosis clinical trials have been reductions in vertebral fractures, hip fractures and non-vertebral fractures. The challenge becomes to find the commonly deducible measures between the treatment information that is available on each drug and the payment system for the outcomes targeted for reduction. In this example, the commonly deducible measures are clinical vertebral fracture, hip fracture and a catch-all category called “all other”. From this point forward these will be referred to as measures X, Y and Z.

Consistent with step 5a of FIG. 2, the system can calculate the expected improvements for Drug A and Drug B on the commonly deducible measures. Fortunately, most major osteoporosis clinical trials are three years in length, which will aid in the extrapolation of data into this analysis, but factors such as the admission criteria for each trial and the baseline characteristics of each patient population must be taken into account. The real-world situation which these systems and methods are designed to make predictions about may require that the system calculate adjustments to the inputted data. At the end of this step, the system produces values such as: For measures X, Y and Z, Drug A is expected to show improvements of 10%, 5% and 0% over 3 years while drug B is expected to show improvements of 60%, 40% and 20%.

Consistent with step 4b of FIG. 2, the five outcomes that were targeted for reduction and their expected incidence in the osteoporosis patient population are converted over to measures X, Y and Z. Additionally, the costs associated with each measure are calculated by the system. Adjustments for real-world variables also can be calculated by the system at this point. At the end of this step, the system provides general values such as: for measures X, Y and Z, over the next three years the plan expects to spend $10 million, $40 million, and $20 million if none of the osteoporosis patients in the plan are treated.

Step 6 of FIG. 2, the system combines the information from steps 4b and 5a to yield results such as: For measures X, Y and Z the company can expect to pay $9 million, $38 million and $20 million with Drug A, whereas for Drug B the expected costs are $4 million, $24 million and $16 million. The cost of each treatment from step 3c can then be factored into the analysis by the system and consistent with step 7 any downstream/ancillary costs can be adjusted for. As an example, what if labs to monitor liver function were required every 6 months with Drug B, then those could be accounted for at this point. This would then yield the final total expected treatment costs seen in step 8.

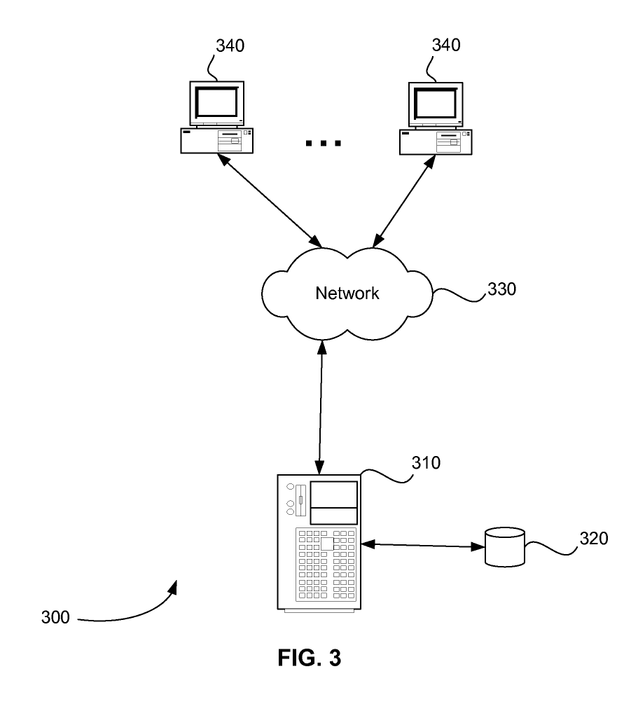

FIG. 3 is schematic diagram of a system 300 for predicting expected disease outcome costs based on healthcare treatment options, in accordance with various embodiments.

System 300 includes computer 310 and electronic database 320. Computer 310 is, for example, a server computer. Computer 310 can also be a client computer. If computer 310 is a server computer. It can be accessed through network 330 by client computers 340, for example.

Electronic database 320 is shown directly connected to computer 310. Electronic database 320 can also be connected to computer 310 through network 330, for example. Electronic database 320 is shown as one physical database. In various embodiments electronic database 320 can include two or more physical database. Electronic database 320 can include one more logical databases. Electronic database 320 can include only electronic components or any combination of electronic and magnetic components.

Computer 310 receives a disease state of a patient population of interest, two or more disease outcomes targeted for improvement, two or more treatments, costs for two or more disease outcomes targeted for improvement, and costs for the two or more treatments. A disease state is, for example, osteoporosis. A population of interest is, for example, women between the age of 45 and 70. Two or more disease outcomes targeted for improvement can include hip fractures, vertebral fractures, pelvic fractures, wrist fractures, and a catch-all category for all other fractures, for example. Two or more treatments can include, for example, two or more osteoporosis drugs.

Computer 310 searches electronic database 320 for treatment outcome data that provides expected effects of the two or more treatments for the disease state. The treatment outcome data can include clinical trial data or claims data from a healthcare insurer.

Computer 310 creates two or more deducible measures from the search that are a subset of the two or more treatment outcomes targeted for improvement. The two or more deducible measures can include, for example, hip fractures, vertebral fractures, and a catch-all category for all other fractures. The treatment outcome data did not include enough information for pelvic fractures and wrist fractures, for example.

Computer 310 assigns improvement values to the two or more deducible measures for each treatment of the two or more treatments for a time period based on the expected effects found in the search. Computer 310 assigns improvement values of 10%, 5%, and 0% to the two or more deducible measures over 3 years for a first treatment and improvement values of 60%, 40% and 20% to the two or more deducible measures over 3 years for a second treatment, for example.

Computer 310 calculates cost values for each of the two or more deducible measures for no treatment and for each treatment of the two or more treatments for the time period. The cost values are calculated from the improvement values, the costs for two or more disease outcomes targeted for improvement, and the costs for the two or more treatments.

For example, computer 310 calculates costs of $10 million, $40 million, and $20 million for the deducible measures if no treatments are used. Computer 310 calculates cost values of $9 million, $38 million, and $20 million for the deducible measures if a first treatment is used $4 million, $24 million, and $16 million for the deducible measures if a second treatment is used.

In various embodiments, computer 310 searches electronic database 320 for a discontinuation rate of the two or more treatments over the time period. Computer 310 calculates the cost values for each of the two or more deducible measures for no treatment and for each treatment of the two or more treatments for the time period using the discontinuation rate of the two or more treatments.

In various embodiments, computer 310 searches electronic database 320 for a compliance rate of the two or more treatments over the time period. Computer 310 calculates the cost values for each of the two or more deducible measures for no treatment and for each treatment of the two or more treatments for the time period using the compliance rate of the two or more treatments.

In various embodiments, computer 310 searches electronic database 320 for patent exclusivity information of the two or more treatments over the time. Computer 310 calculates the cost values for each of the two or more deducible measures for no treatment and for each treatment of the two or more treatments for the time period using the patent exclusivity information of the two or more treatments.

In various embodiments, computer 310 searches electronic database 320 for ancillary costs of the two or more treatments over the time. Computer 310 calculates the cost values for each of the two or more deducible measures for no treatment and for each treatment of the two or more treatments for the time period using the ancillary costs of the two or more treatments. The ancillary costs include a laboratory test cost, for example.

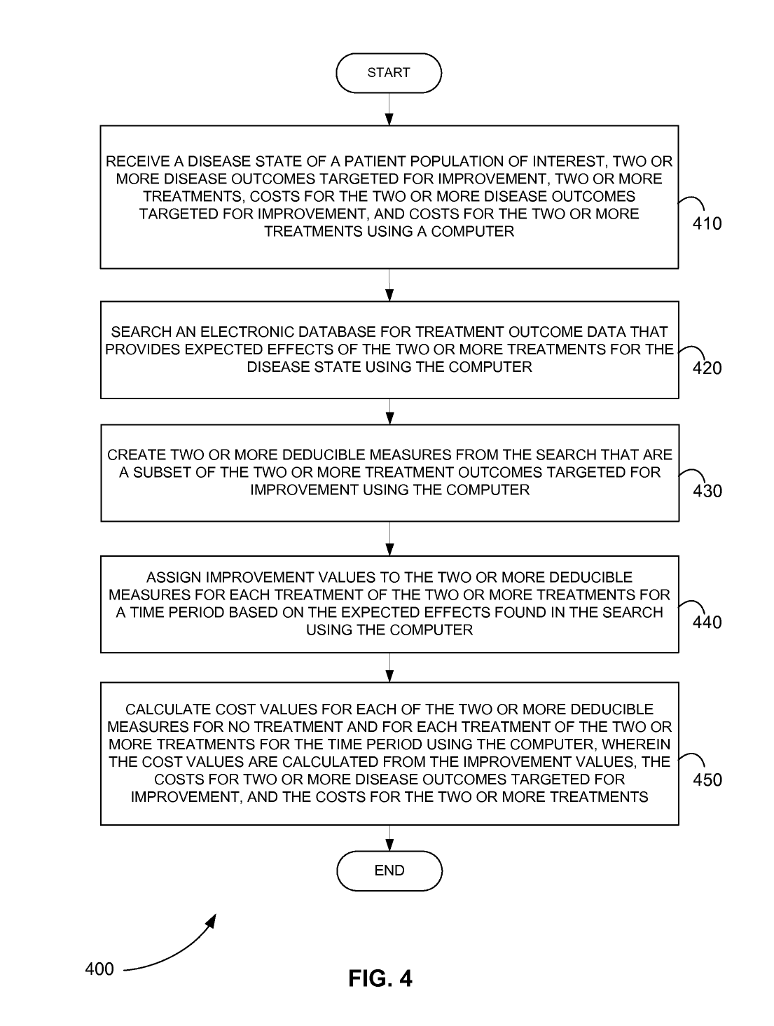

FIG. 4 is an exemplary flowchart showing a method 400 for predicting expected disease outcome costs based on healthcare treatment options, in accordance with various embodiments.

In step 410 of method 400, a disease state of a patient population of interest, two or more disease outcomes targeted for improvement, two or more treatments, costs for the two or more disease outcomes targeted for improvement, and costs for the two or more treatments are received using a computer.

In step 420, an electronic database is searched for treatment outcome data that provides expected effects of the two or more treatments for the disease state using the computer.

In step 430, two or more deducible measures are created from the search that are a subset of the two or more treatment outcomes targeted for improvement using the computer.

In step 440, improvement values are assigned to the two or more deducible measures for each treatment of the two or more treatments for a time period based on the expected effects found in the search using the computer.

In step 450, cost values are calculated for each of the two or more deducible measures for no treatment and for each treatment of the two or more treatments for the time period using the computer. The cost values are calculated from the improvement values, the costs for two or more disease outcomes targeted for improvement, and the costs for the two or more treatments.

In various embodiments, a computer program product includes a non-transitory and tangible computer-readable storage medium whose contents include a program with instructions being executed on a computer so as to perform a method for predicting expected disease outcome costs based on healthcare treatment options. This method is performed by a system that includes one or more distinct software modules.

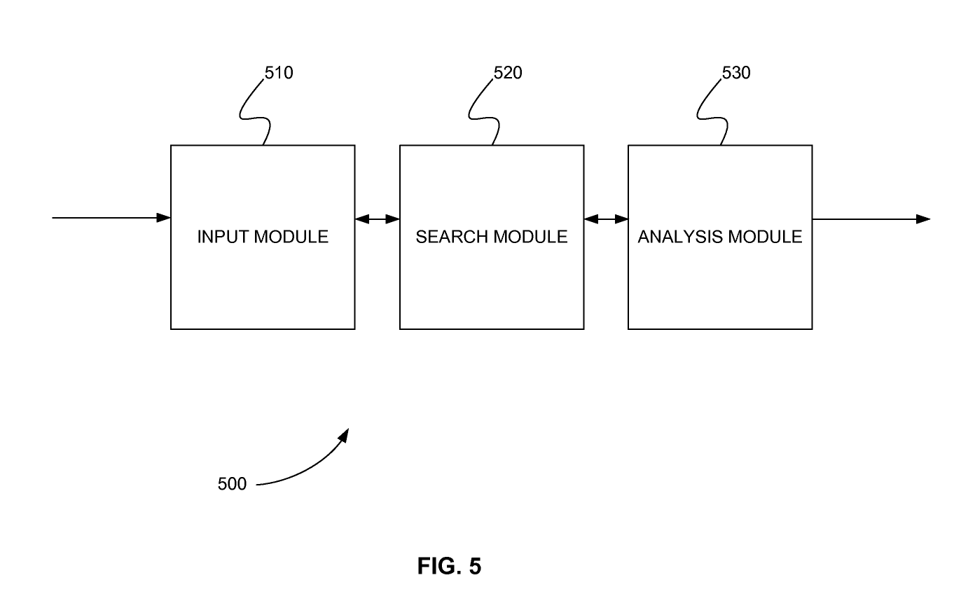

FIG. 5 is a schematic diagram of a system 500 that includes one or more distinct software modules that perform a method for predicting expected disease outcome costs based on healthcare treatment options, in accordance with various embodiments. System 500 includes input module 510, search module 520, and analysis module 530.

Input module 510 receives a disease state of a patient population of interest, two or more disease outcomes targeted for improvement, two or more treatments, costs for the two or more disease outcomes targeted for improvement, and costs for the two or more treatments. Search module 520 searches an electronic database for treatment outcome data that provides expected effects of the two or more treatments for the disease state. Analysis module 530 creates two or more deducible measures from the search that are a subset of the two or more treatment outcomes targeted for improvement. Analysis module 530 assigns improvement values to the two or more deducible measures for each treatment of the two or more treatments for a time period based on the expected effects found in the search. Analysis module 530 calculates cost values for each of the two or more deducible measures for no treatment and for each treatment of the two or more treatments for the time period. The cost values are calculated from the improvement values, the costs for two or more disease outcomes targeted for improvement, and the costs for the two or more treatments.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A system for predicting expected disease outcome costs based on healthcare treatment options, comprising:
an electronic database; and
a computer that
receives a disease state of a patient population of interest, two or more disease outcomes targeted for improvement, two or more treatments, costs for the two or more disease outcomes targeted for improvement, and costs for the two or more treatments,
searches the electronic database for treatment outcome data that provides expected effects of the two or more treatments for the disease state,
creates two or more deducible measures from the search that are a subset of the two or more treatment outcomes targeted for improvement,
assigns improvement values to the two or more deducible measures for each treatment of the two or more treatments for a time period based on the expected effects found in the search,
calculates cost values for each of the two or more deducible measures for no treatment and for each treatment of the two or more treatments for the time period, wherein the cost values are calculated from the improvement values, the costs for two or more disease outcomes targeted for improvement, and the costs for the two or more treatments.

2. The system of claim 1, wherein the computer searches the electronic database for a discontinuation rate of the two or more treatments over the time period and calculates the cost values for each of the two or more deducible measures for no treatment and for each treatment of the two or more treatments for the time period using the discontinuation rate of the two or more treatments.

3. The system of claim 1, wherein the computer searches the electronic database for a compliance rate of the two or more treatments over the time period and calculates the cost values for each of the two or more deducible measures for no treatment and for each treatment of the two or more treatments for the time period using the compliance rate of the two or more treatments.

4. The system of claim 1, wherein the computer searches the electronic database for patent exclusivity information of the two or more treatments over the time and calculates the cost values for each of the two or more deducible measures for no treatment and for each treatment of the two or more treatments for the time period using the patent exclusivity information of the two or more treatments.

5. The system of claim 1, wherein the computer searches the electronic database for ancillary costs of the two or more treatments over the time and calculates the cost values for each of the two or more deducible measures for no treatment and for each treatment of the two or more treatments for the time period using the ancillary costs of the two or more treatments.

6. The system of claim 5, wherein the ancillary costs comprises a laboratory test cost.

7. The system of claim 1, wherein the treatment outcome data comprises clinical trial data.

8. The system of claim 1, wherein the treatment outcome data comprises claims data from a healthcare insurer.

9. A method for predicting expected disease outcome costs based on healthcare treatment options, comprising:
receiving a disease state of a patient population of interest, two or more disease outcomes targeted for improvement, two or more treatments, costs for the two or more disease outcomes targeted for improvement, and costs for the two or more treatments using a computer;
searching an electronic database for treatment outcome data that provides expected effects of the two or more treatments for the disease state using the computer;
creating two or more deducible measures from the search that are a subset of the two or more treatment outcomes targeted for improvement using the computer;
assigning improvement values to the two or more deducible measures for each treatment of the two or more treatments for a time period based on the expected effects found in the search using the computer; and
calculating cost values for each of the two or more deducible measures for no treatment and for each treatment of the two or more treatments for the time period using the computer, wherein the cost values are calculated from the improvement values, the costs for two or more disease outcomes targeted for improvement, and the costs for the two or more treatments.

10. The method of claim 9, further comprising searching the electronic database for a discontinuation rate of the two or more treatments over the time period and calculating the cost values for each of the two or more deducible measures for no treatment and for each treatment of the two or more treatments for the time period using the discontinuation rate of the two or more treatments using the computer.

11. The method of claim 9, further comprising searching the electronic database for a compliance rate of the two or more treatments over the time period and calculating the cost values for each of the two or more deducible measures for no treatment and for each treatment of the two or more treatments for the time period using the compliance rate of the two or more treatments using the computer.

12. The method of claim 9, further comprising searching the electronic database for patent exclusivity information of the two or more treatments over the time and calculating the cost values for each of the two or more deducible measures for no treatment and for each treatment of the two or more treatments for the time period using the patent exclusivity information of the two or more treatments using the computer.

13. The method of claim 9, further comprising searching the electronic database for ancillary costs of the two or more treatments over the time and calculating the cost values for each of the two or more deducible measures for no treatment and for each treatment of the two or more treatments for the time period using the ancillary costs of the two or more treatments using the computer.

14. The method of claim 13, wherein the ancillary costs comprises a laboratory test cost.

15. The method of claim 9, wherein the treatment outcome data comprises clinical trial data.

16. The method of claim 9, wherein the treatment outcome data comprises claims data from a healthcare insurer.

17. A computer program product, comprising a non-transitory and tangible computer-readable storage medium whose contents include a program with instructions being executed on a processor so as to perform a method for predicting expected disease outcome costs based on healthcare treatment options, the method comprising:
providing a system, wherein the system comprises one or more distinct software modules, and wherein the distinct software modules comprise an input module, a search module, and an analysis module;
receiving a disease state of a patient population of interest, two or more disease outcomes targeted for improvement, two or more treatments, costs for the two or more disease outcomes targeted for improvement, and costs for the two or more treatments using the input module;
searching an electronic database for treatment outcome data that provides expected effects of the two or more treatments for the disease state using the search module;
creating two or more deducible measures from the search that are a subset of the two or more treatment outcomes targeted for improvement using the analysis module;
assigning improvement values to the two or more deducible measures for each treatment of the two or more treatments for a time period based on the expected effects found in the search using the analysis module; and
calculating cost values for each of the two or more deducible measures for no treatment and for each treatment of the two or more treatments for the time period using the analysis module, wherein the cost values are calculated from the improvement values, the costs for two or more disease outcomes targeted for improvement, and the costs for the two or more treatments.

18. The computer program product of claim 17, further comprising searching the electronic database for a discontinuation rate of the two or more treatments over the time period using the search module and calculating the cost values for each of the two or more deducible measures for no treatment and for each treatment of the two or more treatments for the time period using the discontinuation rate of the two or more treatments using the analysis module.

19. The computer program product of claim 17, further comprising searching the electronic database for a compliance rate of the two or more treatments over the time period using the search module and calculating the cost values for each of the two or more deducible measures for no treatment and for each treatment of the two or more treatments for the time period using the compliance rate of the two or more treatments using the analysis module.

20. The computer program product of claim 17, further comprising searching the electronic database for patent exclusivity information of the two or more treatments over the time using the search module and calculating the cost values for each of the two or more deducible measures for no treatment and for each treatment of the two or more treatments for the time period using the patent exclusivity information of the two or more treatments using the analysis module.
